(19) United States
(12) Patent Application Publication
(10) Pub. No.: US 2013/0204869 A1
(43) Pub. Date: Aug. 8, 2013

(54) READING COMPREHENSIBILITY FOR CONTENT SELECTION

(71) Applicants: Evgeniy Gabrilovich, Sunnyvale, CA (US); Bo Pang, Sunnyvale, CA (US); Chenhao Tan, Ithaca, NY (US)

(72) Inventors: Evgeniy Gabrilovich, Sunnyvale, CA (US); Bo Pang, Sunnyvale, CA (US); Chenhao Tan, Ithaca, NY (US)

(73) Assignee: Yahoo, Inc., Sunnyvale, CA (US)

(21) Appl. No.: 13/367,323

(22) Filed: Feb. 6, 2012

(51) Int. Cl. G06F 17/30

(52) U.S. Cl. 707/728; 707/723; 707/E17.014

(57) ABSTRACT

Briefly, embodiments of methods or systems to measure or employ reading comprehensibility are described.

### BACKGROUND

1. Field

This disclosure relates to reading comprehensibility, such as for content selection, as in connection with content delivery or content searching, for example.

2. Information

Media networks strive to encourage users to remain within a particular network or website as such users may be valuable to various advertising entities. For example, the more users which view a particular financial section or website within a media network, the more valuable that financial section or website may become and the more money that potential advertisers may be willing to pay to advertise. Accordingly, given a broad range of users and news articles or other media content available within a media network, a value of the media network may potentially be increased if relevant media content is provided to encourage remaining within the media network for an extended period of time. Therefore, approaches to satisfy desires of users seeking relevant content continue to be sought.

### BRIEF DESCRIPTION OF DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a flow diagram illustrating an embodiment of building a comprehensibility classifier;

FIG. 2 is a flow diagram illustrating an embodiment of determining comprehensibility preference;

FIG. 3 is a flow diagram illustrating an embodiment of a method of employing reading comprehensibility to rank a list of content items;

FIG. 4 is an embodiment of a computing platform or system;

FIG. 5 is a table of a topical arrangement of comprehensibility scored content; and

FIG. 6 is a flow diagram illustrating an embodiment of a method of employing reading comprehensibility to re-rank a list of content items.

Reference is made in the following detailed description to accompanying drawings, which form a part hereof, wherein like numerals may designate like parts throughout to indicate corresponding and/or analogous components. It will be appreciated that components illustrated in the figures have not necessarily been drawn to scale, such as for simplicity and/or clarity of illustration. For example, dimensions of some components may be exaggerated relative to other components. Further, it is to be understood that other embodiments may be utilized. Furthermore, structural and/or other changes may be made without departing from claimed subject matter. It should also be noted that directions and/or references, for example, up, down, top, bottom, and so on, may be used to facilitate discussion of drawings and/or are not intended to restrict application of claimed subject matter. Therefore, the following detailed description is not to be taken to limit claimed subject matter and/or equivalents.

### DETAILED DESCRIPTION

Reference throughout this specification to “one example,” “one feature,” “one embodiment,” “an example,” “a feature,” or “an embodiment” means that a particular feature, structure, or characteristic described in connection with the feature, example or embodiment is included in at least one feature, example or embodiment of claimed subject matter. Thus, appearances of the phrase “in one example,” “an example,” “in one feature,” a feature,” “an embodiment,” or “in one embodiment” in various places throughout this specification are not necessarily all referring to the same feature, example, or embodiment. Furthermore, particular features, structures, or characteristics may be combined in one or more examples, features, or embodiments.

Media networks, such as the Yahoo!™ network, for example, are increasingly seeking ways to keep users within their networks. A media network may, for example, comprise an Internet website or group of websites having one or more sections, for example. An example, the Yahoo!™ network includes websites located within different categorized sections, such as sports, finance, news, and games, to name just a few among possible non-limiting examples. A media network may comprise an Internet-based network or a non-Internet based network, for example.

The more users who remain within a media network for an extended period of time, the more valuable a network may become to potential advertisers and, typically, the more money advertisers may pay to advertise to users, for example, via that media network. In an implementation, searching or use of search engines, often provided to a client device via a server, for example, may deliver relevant content or links, such as hyperlinks, to relevant content, to entice users accessing content, such as via a client device, to remain within a network, such as for a relatively extended period of time. Links to or for content, such as on websites located outside of a media network, may also be presented to users. For example, even if users are directed to websites outside of a particular media network, users may, in effect, remain loyal to the media network in the future if they believe that the media network provides links or otherwise directs them to relevant or interesting content.

According to one or more implementations, as discussed herein, a system or method may be provided for determining or presenting content or links to content, for example, to one or more users, such as via a media network, for example. A personalized approach may be provided by predicting responses to media content items, such as user selections, views or clicks, for example. In other words, content delivery, content links or search results, as examples, may be based at least partially on a likelihood or probability that a user will select, click on or otherwise become engaged in some way with one or more identified content items.

In an embodiment, an approach may be utilized to predict selection, browsing or click behavior for a group of users or for an individual user, as examples. An approach may be employed by an embodiment in which reading comprehensibility of content to be delivered, or for which access is provided, such as via a link, for example, corresponds sufficiently to a reading comprehensibility preference of a user or a group of users so that content made available is more likely to be engaged than otherwise. Although claimed subject matter is not limited in scope to illustrative examples, an approach in which reading comprehensibility is more aligned with a comprehensibility preference of a user may be viewed as movement towards improved personalization or movement towards a more tailored, personalized approach. In this context, we define the term comprehensibility or reading comprehensibility to refer to the degree of difficulty of text judged relative to average sentence length and/or vocabulary size. The term reading comprehensibility score refers to a measure of reading comprehensibility, as explained in more detail below. The term reading comprehensibility preference refers to the reading comprehensibility level preferred for text, such as for an individual. As discussed in more detail below, this preference may be inferred or may be explicitly expressed. Likewise, it may refer to a prediction of a preference, such as for an individual or a particular group, as examples.

The term user refers to an individual for which one or more characteristics are known or may be estimated, for example. A user may be registered within a particular media network, for example. A user may be identified based at least in part on an identifier, such as a user name, or cookies or other identifiers associated with the user and which may be stored on a computer or other access device of the particular user, for example. A user may be associated with a profile which may associate the user with demographics, browsing history, location, age or other attributes, for example. The term content is intended to refer to identified media content, such as or one or more links to media content, as an example. Also, in this context, content specifically refers to content capable of being read as text by a user, which may comprise any one of a variety of forms, including one or more websites, text files, word documents, pdfs, emails, as well as other forms of content. Interactions between users or groups of users of a media network, available content, and/or related electronically accessible information with respect to users, groups of users, or content, may be utilized in one or more embodiments, as described in more detail below.

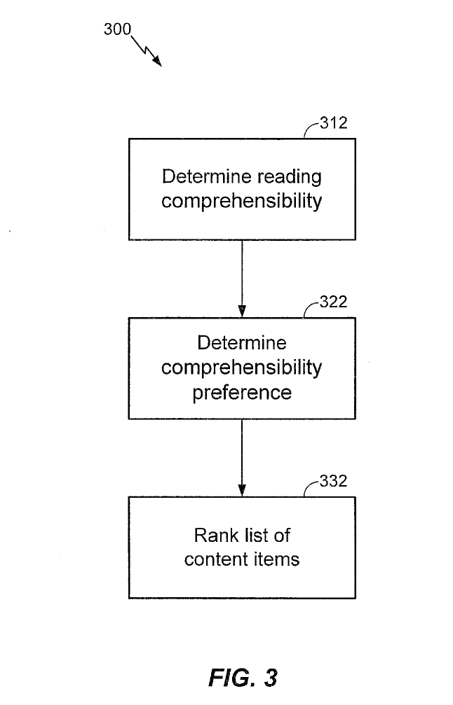

FIG. 3 is an example embodiment 300 of a method to measure or employ reading comprehensibility, such as for content selection, content delivery or the like, as non-limiting examples. In embodiment 300, as shown at block 312, reading comprehensibility of a list of content items may be determined or evaluated. For example, a reading comprehensibility score may be obtained for the items of the list. Likewise, as shown at block 322, a reading comprehensibility preference may be determined or evaluated. For example, a group or an individual reading comprehensibility preference may be obtained. Further, as shown by block 332, content items may be ranked based at least in part on a correspondence between reading comprehensibility of the items and a particular or a general reading comprehensibility preference, such as a topically related or non-topically related preference, as explained in more detail later. Likewise, in an embodiment, as described in more detail later, collaborative filtering may be employed in an embodiment. Of course, these are illustrations of example embodiments and claimed subject matter is not limited to a particular illustrative embodiment. Nonetheless, these and other embodiments shall be described in more detail below and throughout this document.

In an embodiment, as alluded to previously, one particular type of preference in content selection, namely, reading comprehensibility of relevant content may be used. Relevance with respect to content comprises a well-studied discipline and need not be described in further detail here. However, different users may also have individual preferences regarding easier or more sophisticated text, for example. Therefore, as an illustration of a possible embodiment, in a relevance-type ranking of content items, re-ranking to at least partially take into account reading comprehensibility may produce an increase in views or clicks, for example, than may otherwise result where content is available or accessible electronically. Of course, in another embodiment, a list of content items may be ranked substantially in accordance with reading comprehensibility without significant regard to relevance, for example, as shall also be described.

In an embodiment, reading comprehensibility may be measured or determined using a classifier, as has been employed in accordance with machine learning or other statistically related disciplines, for example. A classifier may create a reading comprehensibility-type ranking for a list of content items and/or may assign reading comprehensibility scores. Likewise, in some embodiments, content, such as in the form of text, for example, may be topical or topically related. Topical or topically related in this context is intended to refer to a characteristic of separate content items sufficiently similar in subject matter to be perceived as relevant to a common identifiable topic. Thus, in another illustrative embodiment, a list of topically related content items may be ranked or scored substantially in accordance with a topically related reading comprehensibility preference, as shall be explained in more detail later.

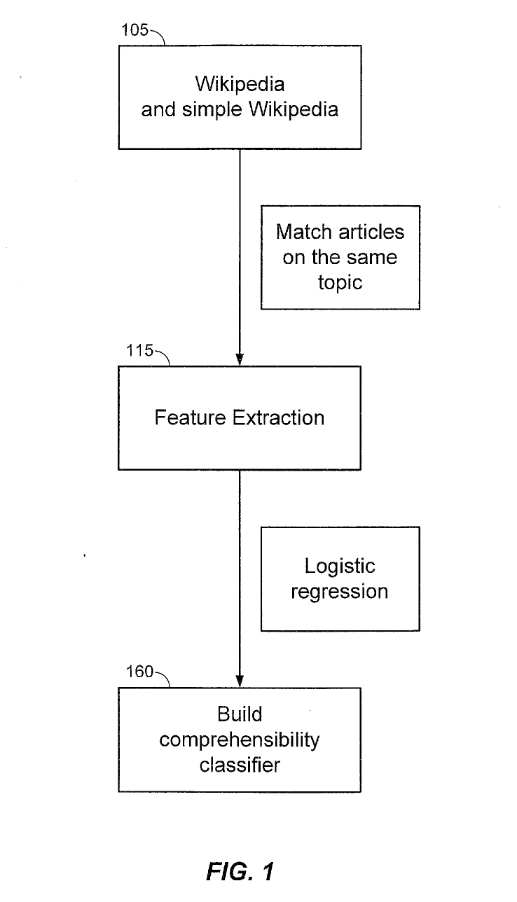

Referring to FIG. 1, a classifier 160 may be generated, again, such as by using machine learning or other statistical techniques. In an embodiment, a labeled set of content, illustrated by 105, may be generated by selecting pages from a source of simple text (e.g., Simple English Wikipedia (Wₛ)) and a corresponding source of complex text (e.g., English Wikipedia (Wₑₙ)). Articles in Simple Wikipedia are, in general, written using Basic English, a subset of English with a restricted vocabulary and simple rules of grammar. At least some articles in Wₛ may be aligned to corresponding articles in Wₑₙ. In this example, however, overly short articles, such as segments with fewer than 100 characters and documents with fewer than 50 words, may be discarded. Here, 40,032 aligned article pairs were identified. For an aligned pair of articles, for example, an article from Wₛ may be labeled as “easy” (or 0), and a corresponding article from Wₑₙ 120 may be labeled as “hard” (or 1) so as to provide a coarse measure of reading comprehensibility.

Features may be extracted at 115 from corresponding sources of simple and complex content, Wₛ and Wₑₙ, respectively, for this example. Features may include one or more common readability indices, such as where word length and/or sentence length are used as proxies of semantic difficulty and/or syntactic complexity, for example. Example readability indices, without limit, may include one or more of Flesch, Flesch-Kincaid, Gunning, ARI, SMOG, or Coleman Liau. A bag of words feature may also be included in an embodiment, for example. It is appreciated that these are illustrative examples of features and claimed subject matter is not limited in scope to these examples.

To build a classifier that is applicable to a broad range of textual content, vocabulary may, for example, be limited to a Basic English 850 word list, such as provided at http://simple.wikipedia.org/wiki/Wikipedia:Basic_English_ordered_wordlist. Features may be weighted by term frequency and normalized, such as by L2 normalization, for example. In an embodiment, these features may be used to train a logistic regression classifier, denoted by 160. A classifier, such as 160, for example, may provide a likelihood or probability of an item of content, an article in this illustrative example, being hard or more difficult to read, which may be referred to as a comprehensibility score (S_{c}) or a reading comprehensibility score.

In one embodiment, various performance metrics for a set of content, such as article pairs, for example, may also be determined. For example, classification accuracy may be evaluated by comparing S_{c} with a threshold of 0.5, which may be employed to implement, in effect, classifying a content item as “easy” or “hard.” However, scores computed for content of widely varying topics may not necessarily be reasonably comparable, for example. Therefore, as an alternate metric, a pairwise score comparison may be evaluated. For example, scores for content from Wₛ may be compared with scores for corresponding content from Wₑₙ, as an example. It is expected that scores for Wₛ content should be below scores for Wₑₙ content for corresponding items. Table 1 illustrates results using 5-fold cross-validation.

TABLE 1

| | | Pairwise |
|---|---|---|
| | Threshold | Comparison |
| Accuracy | 88.30% | 97.40% |

As shown, threshold accuracy is high; however, accuracy of pairwise comparison is even higher. This suggests that S_{c} may be more reliable for comparing comprehensibility of texts on a correspondingly similar or sufficiently specific topic than for texts on different or widely disparate topics, for example.

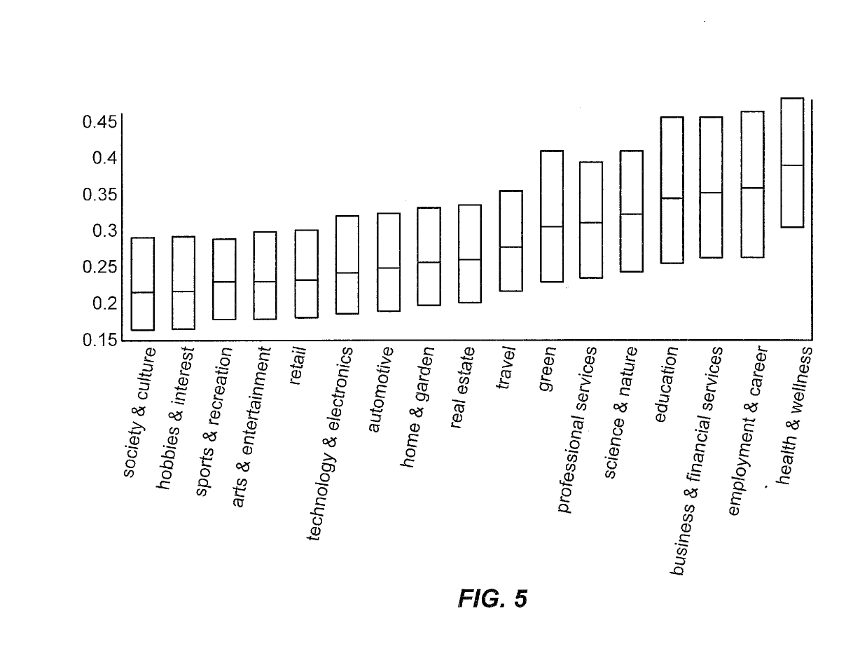

FIG. 5 is a bar chart showing a topical distribution of score, S_{c}, for 154 million content items, here web pages. Center of a bar illustrates a median (50%); section of a bar below the median illustrates a 25^{th} percentile; section of a bar above the median illustrates a 75^{th} percentile. Referring to FIG. 5, relatively easy items in the “health & wellness” category might receive a higher S_{c} score than relatively hard items in “hobbies & interests.” This observation is consistent with the earlier observation that it may be more meaningful to use S_{c} for comparing topical content items, e.g, content items providing subject matter related to a common identifiable specific topic. Different users may likewise have different comprehensibility preferences, which may further vary on a topical basis. In an embodiment, preferences may be captured, for example, by building profiles, such as of users or groups of users, for example, which, in a possible embodiment, may be used to generate or to modify a ranking of content items, as indicated previously, for example.

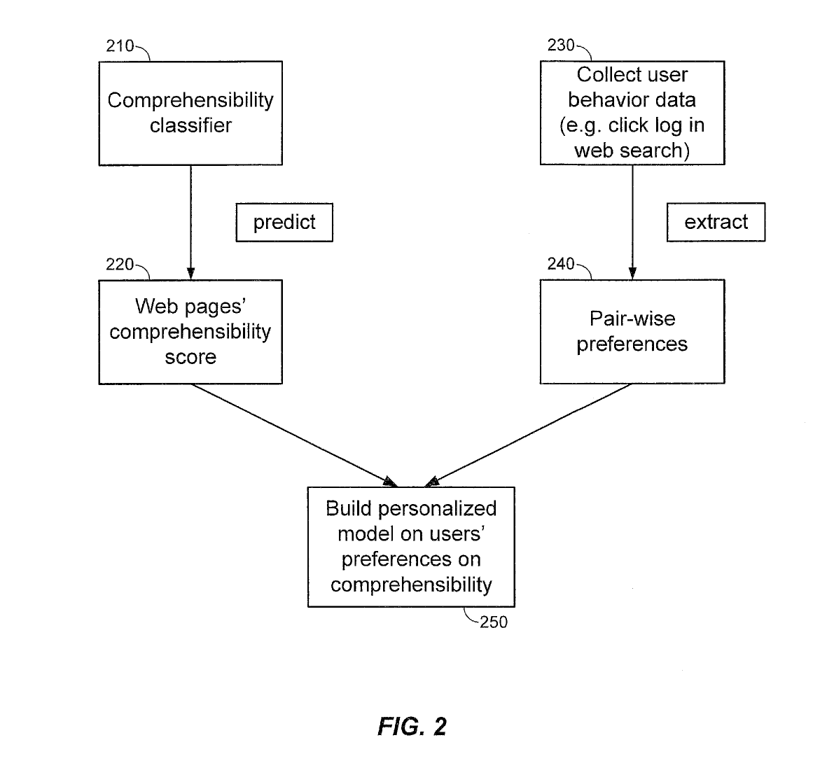

To continue with an example embodiment, referring to FIG. 2, two sets of content were generated for use, one related to search and one related to a community question-answering site (CQA). For example, search results for content items generated by a search engine over a specified period of time may be processed by classifier 160, shown at 210, and a comprehensibility score may be determined, shown at 220, for the content items. For an embodiment, score results may be stored for later use, for example. Alternatively, responses from a CQA over a specified period may receive similar treatment.

Therefore, in this example, web pages returned as search results for a search engine over a specified period of time as one of the top 10 results for submitted queries were crawled, and a comprehensibility classifier was used for scoring these pages. A set was sampled from one month of Yahoo! Web Search query logs. After filtering adult content, the set under went pre-processing. Navigational queries using an automatic navigational query classifier were filtered out, as well as search sessions that resulted in one click on the first result, which may indicate a navigational-type search. For this example, also queries with fewer than 8 results were removed from the set.

Typically, a decision to click on a search result may be influenced by a snippet presented on the search results page, before viewing content of a chosen URL. However, most snippets are broken text segments, and those that happen to have longer “sentences” may have a higher S_{C}. As an alternate to using snippets, the returned pages were aggregated at the domain level and a domain-averaged S_{C} was employed to score the particular page. This approach may also capture a comprehensibility reputation of a domain, which may likewise influence a click or viewing decision.

A page was likewise classified into a proprietary topical hierarchy, which had 17 top-level nodes and 216 nodes in total; “default” was assigned to pages if a classification would be made with relatively low confidence. Statistics were computed over 154,650,334 pages with non-default topical assignments. Similarly, a label from a topical hierarchy was assigned to queries using the returned search results. A resulting set of pages were then split into three parts chronologically: the first 20 days were used for training, the next 5 days for development, and the last 5 days for testing. Furthermore, the study was limited to users with at least 10 queries and at least one click logged in the training set. 424,566 users ultimately were randomly selected.

Yahoo! Answers comprises a community question-answering site. An asker posts a question, which may receive multiple responses from other users. The asker has an option of choosing one of the responses. Here, for a study, a focus was on questions with more than one response among which a response was chosen by the asker. A dump of Yahoo! Answers between January, 2010 and April, 2011 was obtained, where all questions (and responses) in 2010 were used for training and the 4 months in 2011 were used for testing. 85,172 users were randomly selected who had posted at least 10 questions in the training set, and the test set was restricted to these users. The set comprised a total of 4.9 million questions and 39.5 million responses. A response in the set received an S_{C} score from the previously described comprehensibility classifier.

Referring back to FIG. 2, at block 240, pairwise comprehensibility preferences may be determined in an embodiment. Several possible approaches for generating pairwise comprehensibility preferences are illustrated, here using two possible content sources, again described above, as illustrations, are Web search click logs and CQA site responses.

In one example, click logs may be employed to infer comprehensibility preferences. To facilitate description of various methods, it is assumed that a search results page shows 5 results (l₁, l₂, . . . , l₅) and a user clicked on l₂ and l₄.

A first method may employ an assumption of results being browsed in order of presentation. A clicked result is inferred to be “better” than those presented earlier (e.g., viewed) and not clicked. For a ranked list (l₁, l₂, l₃, . . . ) and clicked position set C for user u,

lⱼ>ᵤ lᵢ, if i<j, i ∉ C and j ∈ C.

For the example above, this yields three inferred preference pairs: l₂>u l₁, l₄>u l₁, and l₄>u l₃. A second method contemplates some “noise” and so instead infers a last clicked item to be “better” than those skipped. For a ranked list (l₁, l₂, l₃, . . . ), a clicked position set C for user u, and the position of the last clicked item LC,

lⱼ>ᵤ lᵢ, if i<j, i ∉ C and j=LC

For the example, this yields inferred preferences as follows:

l₄>ᵤ l₁ and l₄>ᵤ l₃.

A third method employs an assumption that the last item clicked is preferred, while all the items above it, including those clicked, are inferior. For a ranked list (l₁, l₂, l₃, . . . ), a clicked position set C for user u, and the position of a clicked item LC,

lⱼ>ᵤ lᵢ, if i<j and j=LC.

For the example, inferred preferences comprise:

l₄>ᵤ l₁, l₄>ᵤ l₂, and l₄>ᵤ l₃.

For a community-type Q&A site, such as Yahoo! Answers, as an example, a similar approach to inferring preferences is possible to employ. As mentioned, the asker is able to label or select a particular response from received responses. If there are n responses for a question a preference pair may be between the selected response and all the other n−1 responses. However, n may vary greatly from question to question. So that preferences carry roughly equivalent weight for different questions, preference pairs are taken with weight 1/n.

Again, referring back to FIG. 2, using pairwise comparisons, for example, a weight may be determined, such as at block 250. Taking into consideration a possible influence of position (e.g., position bias) and relevance, closer in position that two results are, the more likely they are similar in topical relevance, and the more confidence that an inferred comprehensibility preference may be non-topically related. Thus, for a pairwise preference lⱼ>ᵤ lᵢ, a weight may be computed as a function of distance w=2^{-(j-i-1)}. For example, using the second method described above, (l₄,l₁, 0.25) and (l₄, l₃, 1) is obtained.

Continuing to refer to FIG. 2, preference pair weights may be employed with comprehensibility scores previously described with respect to 220. For example, comprehensibility preference pairs may be employed to inform content selection using comprehensibility of content items, such as a comprehensibility score, to thereby generate topical comprehensibility preferences.

As suggested, comprehensibility preferences may be generated a variety of ways. In one embodiment, as just described in connection with FIG. 2, online selection or browsing behavior, such as captured via click logs for a given time period, for example, may be employed. Several example methods were described, although, of course, these are merely illustrative examples. In this context, this may be referred to as inferring a comprehensibility preference. Likewise, alternately, an explicit comprehensibility preference may be solicited or provided, for example. It is intended that claimed subject matter not be limited to these illustrations, of course.

Likewise, as previously indicated, comprehensibility preferences may be topical or non-topical. For example, in one embodiment, a non-topical or topic independent comprehensibility preference may be generated. For a user u, let a>ᵤ b denote preference of content item a over b. One example method to obtain a set of n preference pairs may comprise

Ωᵤ^{pref}:={(<aᵢ, bᵢ>, wᵢ)|aᵢ>u bᵢ, with weight wᵢ} (1)

In one embodiment, employing equal weights (wᵢ=1), a random variable X with a Bernoulli distribution parameterized by p, may take a value 1 if a preference is demonstrated for harder content. Using a sample of size n (X₁=x₁, . . . , Xₙ=xₙ), corresponding to n preference pairs of content items,

$${x}_{i} = \{ \begin{matrix}1 , & {S}_{c} ( {a}_{i} ) > {S}_{c} ( {b}_{i} ) \\ 0 , & {S}_{c} ( {a}_{i} ) < {S}_{c} ( {b}_{i} )\end{matrix} \qquad ( 2 )$$

with pairs ordered to reflect a preference for aᵢ over bᵢ (e.g., aᵢ>bᵢ)). Pᵤ, the probability of preferring harder content, also referred to as reading comprehensibility preference, may be estimated, the estimator being computed as follows:

k=Σᵢxᵢ (3)

A maximum likelihood estimator (k/n) may be less desirable for n being relatively small. In an embodiment, a Laplace estimator of p may be employed, which uses Uniform (0, 1) as a prior distribution. A posterior estimation of Pᵤ may have the follow form:

$${Ω}_{u}^{pref} \text{:} {P}_{u = f ( {Ω}_{u}^{pref} ) = \frac{k + 1}{n + 2}} \qquad ( 4 )$$

In one possible embodiment, content may be presented substantially in accordance with an estimate of likelihood of preference for reading comprehensibility independent of topic, e.g., a non-topical reading comprehensibility preference, such as in accordance with an estimated Pᵤ. In another embodiment, however, varying weights may generate topical reading comprehensibility preferences, as follows

$${P}_{u}^{( w )} = {f}^{( w )} ( {Ω}_{u}^{pref} ) = \frac{{k}^{( w )} + 1}{{n}^{( w )} + 2} , \qquad ( 5 )$$

where k^{(w)}=Σᵢwⁱxⁱ, n^{(w)}=Σᵢwᵢ.

This reduces to, Pᵤ, a non-topical reading comprehensibility preference for ∀i, wᵢ=1.

In general, embodiments described below may employ varying weights, for content not all in substantially similar topic areas, e.g., for topical preferences, or substantially the same weights for generic or non-topical reading comprehensibility preferences. In an embodiment, a set of content items, e.g., results of a search returned for a query, may be classified into a topical hierarchy, where a root node treats all topics similarly, however, otherwise content classified substantially in accordance with topic may have a topical reading comprehensibility preference.

In an embodiment, for example, preferences, such as for an individual, may be generated for topics or categories, denoted Ω_{u,t}^{pref} using Ωᵤ^{pref}, in an example. An order relationship may be characterized, for example, between two topic categories in a topical hierarchy as follows:

t₂<ₕ t₁ [symbol] t₂ is a descendant of t₁ (6)

For a preference pair ppᵢ ∈ Ωᵤ^{pref}, let tᵢ comprise a topic category of a topical hierarchy, and let

Ω_{u,t}^{pref}={ppᵢ ∈ Ωᵤ^{pref}|t_{i≧}_{ₕ} t}

For any reasonably sized Ω_{u,t}^{pref} (i.e., Ωᵤ^{pref}|>0), P_{u,t}=f(Ω_{u,t}^{pref}) may be computed, such as in the manner described above.

However, enough observations for every possible (u, t) pair to reliably compute P_{u,t} may not necessarily be available at least for some topic categories. In one embodiment, a topic-independent computation may be employed, in an embodiment, for example. For example, if P_{u,t} may be estimated, P_{u,t} may be used; otherwise, Pᵤ may be used, for an embodiment.

In an alternate embodiment, collaborative filtering may also be used to at least partially address a lack of topic-specific reading comprehensibility preferences for a topical hierarchy. For example, if certain correlations exist between comprehensibility preferences for some topics in a hierarchy, then observed comprehensibility preferences may be used to predict comprehensibility preferences.

Formally, let nᵤ be the number of users, and nₜ be the number of topics. A matrix G^{nu×nt} may be generated, where Gᵢⱼ is the likelihood of user i preferring harder content in topic j substantially in accordance with estimation. Note that for cells (i, j) without observations, a value for G_{i,j} reflecting a global value may be employed. This may be accomplished by computing the global mean of all P_{u,t} values estimated from observations as

$$g = \frac{1}{{\sum }_{u} {\sum }_{t} I ( {P}_{u , t} \neq 0 )} {\sum }_{u} {\sum }_{t} {P}_{u , t} . \qquad ( 7 )$$

and let

$${G}_{ut} = \{ \begin{matrix}{P}_{u , t} - g , & {Ω}_{u , t}^{pref} \neq ∅ \\ O , & otherwise .\end{matrix} \qquad ( 8 )$$

so that a value of 0 may be employed in those case. In an embodiment, a maximum-margin matrix factorization approach may be employed, similar to collaborative filtering techniques, in which an approximation of G is computed with a low-rank decomposition U^{T}V. That is, an objective function of the following form may be used in a computation:

$${\sum }_{i , j , {G}_{ij} \neq 0} {‖ {U}^{T} {V}_{( ij )} - {G}_{ij} ‖}^{2} + {‖ U ‖}_{F} + {‖ V ‖}_{F} \qquad ( 9 )$$

U and V may be obtained, for example, using CofiRank, an available rank reduction program, to solve relationship (9) as an objective function.

G^{cf}=U^{T}V+g (10)

may be computed. For example, if P_{u,t} cannot be reliably estimated, Gᵤₜ^{cf} may be computed using a collaborative filtering approach, such as in accordance with a previously described embodiment. Likewise, Pᵤ may be used if a topic category is not available, for example.

In an embodiment, content selection at least partially in accordance with reading comprehensibility may be implemented in conjunction with relevance ranking, as was suggested previously. As an illustrative example, in web search, for example, an initial relevance-type ranking, as described previously, for example, search results returned for a corresponding query, may be re-ranked in accordance with comprehensibility preference.

In an alternate embodiment, such as where relevance ranking is not available or is not utilized, another approach may be employed. As an illustrative example, in community question-answering (CQA), for example, responses may be provided in a manner so that a particular response of available responses is employed, as was described. In the latter case, there might not exist any native ranking of responses. Therefore, ranking may be generated substantially in accordance with comprehensibility preference, in an embodiment.

In an illustrative case, for an embodiment, for example, where a topic-relevance-type ranking R for a set of content items D, exists or is otherwise provided. R(d) may comprise for an embodiment the rank of d ∈ D given by R. Rᵤ may comprise a ranking over D in descending order of comprehensibility score Sc, for example. Pᵤ denotes a comprehensibility preference generated by any one of a variety of approaches, as discussed previously, for example. However, for an embodiment, a combined ranking of items may comprise, for example, an ascending order of the following value:

R(d)+β*(2*Pᵤ−1)*Rᵤ(d) (11)

In an embodiment, a parameter may affect relative impact of comprehensibility (Rᵤ). Rᵤ may be varied depending at least partially, for example, on comprehensibility preference, such as, for example, how much Pᵤ deviates from 0.5, referred to below as preference saliency. Furthermore, Rᵤ may be reversed if comprehensibility preference is oriented in favor of easier content (Pᵤ<0.5). Thus, in this illustrative embodiment, a second term may be multiplied by (2*Pᵤ−1) to allow personalized adjustment over parameter β. Of course, claimed subject matter is not limited in scope to this illustration.

A notion of preference saliency may be characterized as follows:

Qᵤ=|Pᵤ−0.5|,

where Pᵤ comprises a computed comprehensibility preference, for example. For users with higher saliency, improvement from employing comprehensibility-personalization may also be more pronounced, and improvements obtained for various topics with respect to saliency may also be determined, if desired. To this end, for a configuration, users may be ranked substantially in accordance with Qᵤ on a topical basis and improvement over a baseline for top k % users may be reported, for different values of k, for example, A parameter β (described above) may be tuned on a development set. For example, a value of 0.4 appears to provide good results. Improvement of comprehensibility-type ranking appears to be roughly between 20% and 30% compared to an initial topical-relevance type ranking, for users with pronounced preferences in accordance with salience.

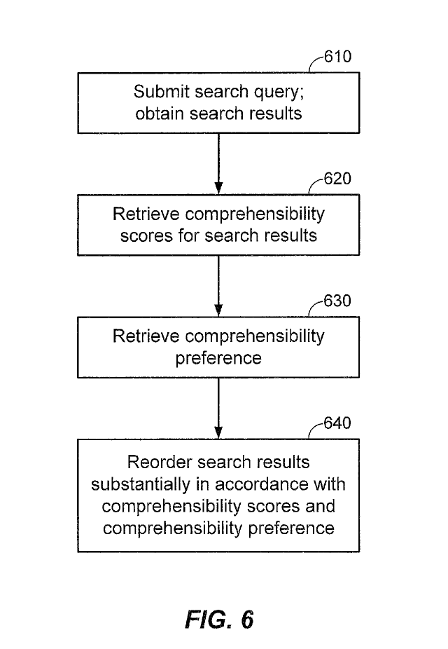

A block diagram of an example embodiment is illustrated in FIG. 6. For example, a user may submit a search query, illustrated at 610, and obtain search results. Comprehensibility scores for the web pages resulting from a query may be retrieved, such as indicated at 620. Comprehensibility preference for a user, for example, who made the query, may be retrieved, such as indicated at 630. Reordering or re-ranking resulting in search results ordered substantially in accordance with comprehensibility preference and comprehensibility scores may be produced indicated at 640.

In an example embodiment, a server or server system may be in communication with client resources, such as a computing platform, via a communication network. A communication network may comprise one or more wireless or wired networks, or any combination thereof. Examples of communication networks may include, but are not limited to, a Wi-Fi network, a Wi-MAX network, the Internet, the web, a local area network (LAN), a wide area network (WAN), a telephone network, or any combination thereof, etc.

A server or server system, for example, may operatively be coupled to network resources or to a communications network, for example. An end user, for example, may communicate with a server system, such as via a communications network, using, e.g., client resources, such as a computing platform. For example, a user may wish to access one or more content items, such as related to a topical category based at least in part on comprehensibility.

For instance, a user may send a content request or a search query. A request or query may be transmitted using client resources, such as a computing platform, as signals via a communications network. Client resources, for example, may comprise a personal computer or other portable device (e.g., a laptop, a desktop, a netbook, a tablet or slate computer, etc.), a personal digital assistant (PDA), a so-called smart phone with access to the Internet, a gaming machine (e.g., a console, a hand-held, etc.), a mobile communication device, an entertainment appliance (e.g., a television, a set-top box, an e-book reader, etc.), or any combination thereof, etc., just to name a few examples. A server or server system may receive, via a communications network, signals representing a request or query that relates to a content item or topical category. A server or server system may initiate transmission of signals to provide content related suggestions or recommendations, for example, related to relevance, topical category and/or reading comprehensibility.

Client resources may include a browser. A browser may be utilized to, e.g., view or otherwise access content, such as, from the Internet, for example. A browser may comprise a standalone application, or an application that is embedded in or forms at least part of another program or operating system, etc. Client resources may also include or present a graphical user interface. An interface, such as GUI, may include, for example, an electronic display screen or various input or output devices. Input devices may include, for example, a microphone, a mouse, a keyboard, a pointing device, a touch screen, a gesture recognition system (e.g., a camera or other sensor), or any combinations thereof, etc., just to name a few examples. Output devices may include, for example, a display screen, speakers, tactile feedback/output systems, or any combination thereof, etc., just to name a few examples. In an example embodiment, a user may submit a request for content or a request to access content via an interface, although claimed subject matter is not limited in scope in this respect. Signals may be transmitted via client resources to a server system via a communications network, for example. A variety of approaches are possible and claimed subject matter is intended to cover such approaches.

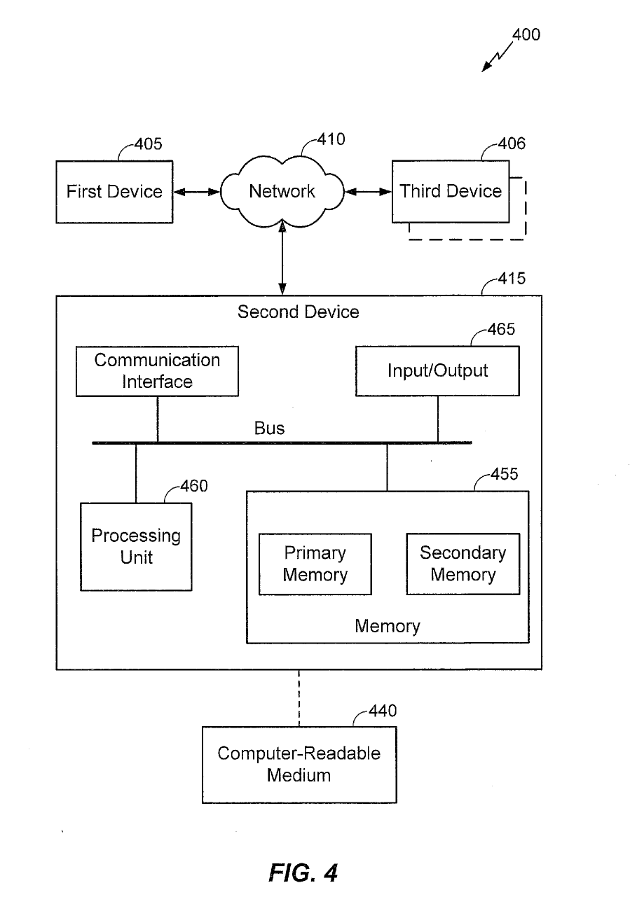

FIG. 4 is a schematic diagram of a system 400 that may include a server 405, a network 410, and a computing platform 415, such as for user access. Server 405 may jointly process comprehensibility preferences with respect to users and may determine content for serving to one or more users, as discussed above. Although one server 405 is shown in FIG. 4, it should be appreciated that multiple servers may perform joint processing. Server 405 may include a transmitter, a receiver, a processor, and a memory.

In one or more implementations, a modem or other communication device capable of transmitting and/or receiving electronic signals may be utilized instead of or in addition to a transmitter and/or a receiver. A transmitter may transmit one or more electronic signals containing media content or links to media content to computing platform 415 via network 410, for example. A receiver may receive one or more electronic signals which may contain samples, states or signals relating to information about users and/or content, for example.

A processor may be representative of one or more circuits, such as digital circuits, to perform at least a portion of a computing procedure or process. By way of example but not limitation, a processor may include one or more processors, controllers, microprocessors, microcontrollers, application specific integrated circuits, digital signal processors, programmable logic devices, field programmable gate arrays, and the like, or any combination thereof.

A memory is representative of any storage mechanism. A memory may include, for example, a primary memory or a secondary memory. A memory may include, for example, a random access memory, read only memory, or one or more data storage devices or systems, such as, for example, a disk drive, an optical disc drive, a tape drive, a solid state memory drive, to name just a few examples. A memory may be utilized to store state or signal information relating to users and/or content, for example. A memory may comprise a computer-readable medium that may carry and/or make accessible content, code and/or instructions, for example, executable by a processor or some other controller or processor capable of executing instructions, for example.

Network 410 may comprise one or more communication links, processes, and/or resources to support exchanging communication signals between server 405 and computing platform 415. By way of example but not limitation, network 410 may include wireless and/or wired communication links, telephone or telecommunications systems, data buses or channels, optical fibers, terrestrial or satellite resources, local area networks, wide area networks, intranets, the Internet, routers or switches, and the like, or any combination thereof.

A computing platform 415 may comprise one or more computing devices and/or platforms, such as, e.g., a desktop computer, a laptop computer, a workstation, a server device, or the like; one or more personal computing or communication devices or appliances, such as, e.g., a personal digital assistant, mobile communication device, or the like; a computing system and/or associated service provider capability, such as, e.g., a database or data storage service provider/system, a network service provider/system, an Internet or intranet service provider/system, a portal and/or search engine service provider/system, a wireless communication service provider/system; and/or any combination thereof.

A computing platform 415 may include items such as a transmitter, a receiver, a display, a memory 455, a processor 460, or user input device 465. In one or more implementations, a modem or other communication device capable of transmitting and/or receiving electronic signals may be utilized instead of or in addition to a transmitter and/or a receiver. A transmitter may transmit one or more electronic signals to server 405 via network 410. A receiver may receive one or more electronic signals which may contain content or provide access to content, for example. A display may comprise an output device capable of displaying visual signals or states, such as a computer monitor, cathode ray tube, LCD, plasma screen, and so forth.

Memory 455 may store cookies relating to one or more users and may also comprise a computer-readable medium 440 that may carry and/or make accessible content, code and/or instructions, for example, executable by processor 460 or some other controller or processor capable of executing instructions, for example. User input device 465 may comprise a computer mouse, stylus, track ball, keyboard, or any other device capable of receiving an input, such as from a user.

The term “computing platform” as used herein refers to a system and/or a device that includes the ability to process and/or store data in the form of signals and/or states. Thus, a computing platform, in this context, may comprise hardware, software, firmware or any combination thereof (other than software per se). Computing platform 415, as depicted in FIG. 4, is merely one such example, and the scope of claimed subject matter is not limited to this particular example. For one or more embodiments, a computing platform may comprise any of a wide range of digital electronic devices, including, but not limited to, personal desktop or notebook computers, high-definition televisions, digital versatile disc (DVD) players and/or recorders, game consoles, satellite television receivers, cellular telephones, personal digital assistants, mobile audio and/or video playback and/or recording devices, or any combination of the above. Further, unless specifically stated otherwise, a process as described herein, with reference to flow diagrams and/or otherwise, may also be executed and/or affected, in whole or in part, by a computing platform.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, and/or characteristic in the singular and/or may be used to describe a plurality or some other combination of features, structures and/or characteristics. Though, it should be noted that this is merely an illustrative example and claimed subject matter is not limited to this example.

In the preceding detailed description, numerous specific details have been set forth to provide a thorough understanding of claimed subject matter. However, it will be understood by those skilled in the art that claimed subject matter may be practiced without these specific details. In other instances, methods and/or apparatuses that would be known by one of ordinary skill have not been described in detail so as not to obscure claimed subject matter. Some portions of the preceding detailed description have been presented in terms of logic, algorithms and/or symbolic representations of operations on binary signals or states stored within a memory of a specific apparatus or special purpose computing device or platform. In the context of this particular specification, the term specific apparatus or the like includes a general purpose computing device, such as general purpose computer, once it is programmed to perform particular functions pursuant to instructions from program software. Algorithmic descriptions and/or symbolic representations are examples of techniques used by those of ordinary skill in the signal processing and/or related arts to convey the substance of their work to others skilled in the art. An algorithm is here, and generally, is considered to be a self-consistent sequence of operations and/or similar signal processing leading to a desired result. In this context, operations and/or processing involve physical manipulation of physical quantities. Typically, although not necessarily, such quantities may take the form of electrical and/or magnetic signals and/or states capable of being stored, transferred, combined, compared or otherwise manipulated as electronic signals and/or states representing information. It has proven convenient at times, principally for reasons of common usage, to refer to such signals and/or states as bits, data, values, elements, symbols, characters, terms, numbers, numerals, information, and/or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing device. In the context of this specification, therefore, a special purpose computer and/or a similar special purpose computing device is capable of manipulating and/or transforming signals and/or states, typically represented as physical electronic and/or magnetic quantities within memories, registers, and/or other information storage devices, transmission devices, and/or display devices of the special purpose computer and/or similar special purpose computing device. In the context of this particular patent application, the term “specific apparatus” may include a general purpose computing device, such as a general purpose computer, once it is programmed to perform particular functions pursuant to instructions from program software.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation and/or a physical change or transformation in molecular structure, such as from crystalline to amorphous or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state form a binary one to a binary zero or vice-versa in a memory device may comprise a transformation, such as a physical transformation. Rather, the foregoing is intended as illustrative examples.

A computer-readable (storage) medium typically may be non-transitory and/or comprise a non-transitory device. In this context, a non-transitory storage medium may include a device that is tangible, meaning that the device has a concrete physical form, although the device may change its physical state. Thus, for example, non-transitory refers to a device remaining tangible despite a change in state.

While there has been illustrated and/or described what are presently considered to be example features, it will be understood by those skilled in the relevant art that various other modifications may be made and/or equivalents may be substituted, without departing from claimed subject matter. Additionally, many modifications may be made to adapt a particular situation to the teachings of claimed subject matter without departing from the central concept(s) described herein. Therefore, it is intended that claimed subject matter not be limited to the particular examples disclosed, but that such claimed subject matter may also include all aspects falling within appended claims and/or equivalents thereof.

1. A method comprising: ranking a list of content items based at least in part on reading comprehensibility of said items and based at least in part on a reading comprehensibility preference.

2. The method of claim 1, wherein said group reading comprehensibility preference comprises an inferred group reading comprehensibility preference.

3. The method of claim 1, wherein said reading comprehensibility preference comprises an individual reading comprehensibility preference.

4. The method of claim 3, wherein said individual reading comprehensibility preference comprises an explicit individual reading comprehensibility preference.

5. The method of claim 3, wherein said individual reading comprehensibility preference comprises an inferred individual reading comprehensibility preference.

6. The method of claim 5, wherein said inferred reading comprehensibility preference comprises a reading comprehensibility preference inferred based at least in part on individual online selection or browsing behavior.

7. The method of claim 6, wherein said inferred reading comprehensibility preference comprises a reading comprehensibility preference inferred based at least in part on pairwise comparisons of individual online selection or browsing behavior.

8. The method of claim 5, wherein said inferred reading comprehensibility preference comprises a reading comprehensibility preference inferred based at least in part on collaborative filtering.

9. The method of claim 1, wherein a reading comprehensibility score at least in part measures reading comprehensibility of an item of content; and said ranking said list comprises ranking said list based at least in part on said reading comprehensibility scores of said items of content of said list.

10. The method of claim 9, wherein said list comprises a list of search results ordered substantially in accordance with relevance to a corresponding search query; and wherein said ranking said list based at least in part on said reading comprehensibility scores comprises re-ranking said list.

11. The method of claim 10, wherein said re-ranking said list comprises re-ranking said list based at least in part on a combination of said reading comprehensibility scores and relevance to said corresponding search query.

12. The method of claim 11, wherein said reading comprehensibility scores comprise topical reading comprehensibility scores and said inferred reading comprehensibility preference comprises a topical reading comprehensibility preference; and wherein said list comprises a list of search results ordered in accordance with relevance to said corresponding search query; and wherein said re-ranking said list comprises ranking said list based at least in part on said topical reading comprehensibility scores for said content items of said list and based at least in part on said topical reading comprehensibility preference.

13. A method comprising: selecting a content item from a re-ranked list of content items, said content items being re-ranked based at least in part on reading comprehensibility of said items and based at least in part on a reading comprehensibility preference.

14. The method of claim 13, wherein said reading comprehensibility preference comprises an inferred reading comprehensibility preference.

15. The method of claim 13, wherein a reading comprehensibility score at least in part measures reading comprehensibility of an item of content; and said re-ranking said list comprises ranking said list based at least in part on reading comprehensibility scores of said items of content of said list.

16. The method of claim 15, wherein said reading comprehensibility scores comprise topical reading comprehensibility scores and said reading comprehensibility preference comprises a topical reading comprehensibility preference; and wherein said list comprises a list of search results ordered in accordance with relevance to said corresponding search query; and wherein said re-ranking said list comprises ranking said list based at least in part on said topical reading comprehensibility scores for said content items of said list and based at least in part on said topical reading comprehensibility preference.

17. An apparatus comprising: a computing platform; said computing platform to rank a list of content items based at least in part on reading comprehensibility of said items and based at least in part on a reading comprehensibility preference.

18. The apparatus of claim 17, wherein said reading comprehensibility preference comprises an inferred reading comprehensibility preference.

19. The apparatus of claim 18, wherein a reading comprehensibility score at least in part measures reading comprehensibility of an item of content; said computing platform to rank said list based at least in part on reading comprehensibility scores of said items of content of said list.

20. The apparatus of claim 19, wherein said reading comprehensibility scores comprise topical reading comprehensibility scores and said reading comprehensibility preference comprises a topical reading comprehensibility preference; said computing platform to rank said list based at least in part on said topical reading comprehensibility scores for said content items of said list and based at least in part on said topical reading comprehensibility preference.
